(19) United States
(12) Patent Application Publication
(10) Pub. No.: US 2012/0290943 A1
(43) Pub. Date: Nov. 15, 2012

(54) METHOD AND APPARATUS FOR DISTRIBUTIVELY MANAGING CONTENT BETWEEN MULTIPLE USERS

(75) Inventors: Aaron Toney, Issaquah, WA (US); Vidyut Samanta, Los Angeles, CA (US); Sean White, Los Angeles, CA (US)

(73) Assignee: Nokia Corporation

(21) Appl. No.: 13/104,241

(22) Filed: May 10, 2011

(51) Int. Cl. G06F 3/01

(52) U.S. Cl. 715/751

(57) ABSTRACT

An apparatus, method, and computer program product are provided for distributively managing content between multiple user devices through the use of collaborative public display regions and/or designated private display regions. The apparatus may include a processor and a memory including computer program code. The memory and the computer program code may be configured, with the processor, to cause the apparatus to receive information regarding a detected device, provide for projection of a collaborative public display region that is shared with the detected device, receive input via a user's interaction with the collaborative public display region, and provide for transfer of the content based on the input received. Where a designated private display region is provided, input via a user's interaction with the designated private display region may be received, and the content may be displayed in the collaborative public display region based on the input received.

### TECHNOLOGICAL FIELD

Embodiments of the present invention relate generally to providing display regions for sharing information between multiple users. In particular, embodiments of the present invention relate to an apparatus and method for providing collaborative public display regions and/or designated private display regions for distributively managing content between multiple users.

### BACKGROUND

The information age has made information available to users through various wired and wireless networks on many different types of devices, from laptop computers to cellular telephones. Along with the increased access to information, however, has come increased user demand for sharing content with other users through their user devices, e.g., without necessarily logging on to a computer to manually copy and transfer files.

Accordingly, it may be desirable to provide an improved mechanism by which a user device may interact with other user devices to display and access information in a collaborative manner, as well as privately.

### BRIEF SUMMARY OF EXAMPLE EMBODIMENTS

An apparatus is therefore provided that allows content to be distributively managed between multiple user devices through the use of collaborative public display regions and/or designated private display regions. The apparatus may include at least one processor and at least one memory including computer program code. The at least one memory and the computer program code may be configured to, with the processor, cause the apparatus to at least receive information regarding a detected device; provide for projection of a collaborative public display region, where the collaborative public display region is shared with the detected device; receive input via a user's interaction with the collaborative public display region regarding management of content displayed in the collaborative public display region; and provide for transfer of the content based on the input received.

The information regarding the detected device may be received based on a proximity of the detected device to the apparatus, and/or the information regarding the detected device may include a position of the detected device. In some cases, receiving information regarding the detected device may initiate a working session. In such cases, the content may be transferred during the working session, and/or the content may be transferred after termination of the working session. The input regarding management of the content may comprise a touch input dragging of the content from the collaborative public display region of the apparatus to a collaborative public display region of one of the detected devices in some embodiments. In other embodiments, the input regarding management of the content may comprise a touch input dragging of the content from a first area of the collaborative public display region to a second area of the collaborative public display region. In addition, providing for the transfer of the content may include providing a copy of the content to the detected device based on the input received.

In some cases, the memory and computer program code may be further configured to, with the processor, cause the apparatus to provide for display of a designated private display region. The memory and computer program code may be further configured to, with the processor, cause the apparatus to receive input via a user's interaction with the designated private display region regarding management of content displayed in the designated private display region and provide for the display of the content in the collaborative public display region based on the input received via the designated private display region.

In other embodiments, a method and a computer program product are provided for distributively managing content between multiple user devices. The method may include receiving information regarding a detected device; providing for projection of a collaborative public display region, where the collaborative public display region is shared with the detected device; receiving input via a user's interaction with the collaborative public display region regarding management of content displayed in the collaborative public display region; and providing for transfer of the content based on the input received. The information regarding the detected device may include a position of the detected device.

Receiving information regarding the detected device may initiate a working session in some cases. The content may be transferred during the working session, and/or the content may be transferred after termination of the working session. In some embodiments, the input regarding management of the content may comprise a touch input dragging of the content from the collaborative public display region of the apparatus to a collaborative public display region of one of the detected devices, whereas in other embodiments the input regarding management of the content may comprise a touch input dragging of the content from a first area of the collaborative public display region to a second area of the collaborative public display region. In addition, the method may include providing for projection of a designated private display region. In some cases, input may be received via a user's interaction with the designated private display region regarding management of content displayed in the designated private display region, and the display of the content may be provided for in the collaborative public display region based on the input received via the designated private display region.

In still other embodiments, an apparatus is provided that includes means for receiving information regarding a detected device; means for providing for projection of a collaborative public display region, wherein the collaborative public display region is shared with the detected device; means for receiving input via a user's interaction with the collaborative public display region regarding management of content displayed in the collaborative public display region; and means for providing for transfer of the content based on the input received.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for distributively managing content between multiple user devices according to an example embodiment of the present invention;

FIG. 3 illustrates an apparatus configured to provide for projection of a collaborative public display region and a designated private display region in accordance with an example embodiment of the present invention;

FIG. 3A is a close-up view of the designated private display region of FIG. 3;

FIG. 4A illustrates three devices arranged to have three areas of overlapping display regions and each device configured to provide for projection of a collaborative public display region and a designated private display region in accordance with an example embodiment of the present invention;

FIG. 4B illustrates three devices arranged to have two areas of overlapping display regions and each device configured to provide for projection of a collaborative public display region and a designated private display region in accordance with another example embodiment of the present invention;

FIG. 5 illustrates three devices having another arrangement with respect to each other and each configured to provide for projection of a collaborative public display region and a designated private display region in accordance with another example embodiment of the present invention;

FIG. 6A illustrates three devices arranged to have three areas of overlapping display regions with content being dragged from a collaborative public display area to a designated private display area of a device;

FIG. 6B illustrates the three devices of FIG. 6A after the content has been dragged from the collaborative public display area to the designated private display area of the device;

FIG. 7 illustrates communication between an apparatus and two detected devices in accordance with an example embodiment of the present invention;

FIG. 8 illustrates an apparatus configured to display a designated private display region on a screen of the apparatus in accordance with an example embodiment of the present invention;

FIG. 9 illustrates the apparatus of FIG. 8 in which a Public folder is provided for transferring content from the designated private display region to a collaborative public display region of the apparatus in accordance with an example embodiment of the present invention; and

FIGS. 10 and 11 illustrate a flowchart of a method of distributively managing content between multiple user devices in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Devices for providing content to users are becoming smaller and more portable, allowing users to carry the devices with them virtually everywhere. As a result, users can have access to content stored on the devices or available through the devices (e.g., via the Internet) at home, in the office, or on the road and are not confined to accessing content only in certain situations or locations.

Coupled with this increased portability is the increasing popularity and utility of content sharing between and among users. From e-mailing to texting to social networking, users want to be in touch with other users and want to transfer and download content with friends and co-workers. In the workplace setting, for example, a team meeting may take place in a conference room, and each team member may have a content file on his or her mobile device that needs to be shared with the other team members. Rather than gathering around a single device to view content and share ideas, then sending the collaboratively modified files to the other members of the team later (for example, via e-mail once the team members are back at their desks), it may be helpful to allow the users to view and manipulate content and transfer the content to each other via a shared display region that provides an interface for receiving input from any of the users.

Accordingly, embodiments of the apparatus, method, and computer program product described below provide for the distributive management of content between multiple user devices through the use of collaborative public display regions and/or designated private display regions, as described in greater detail below.

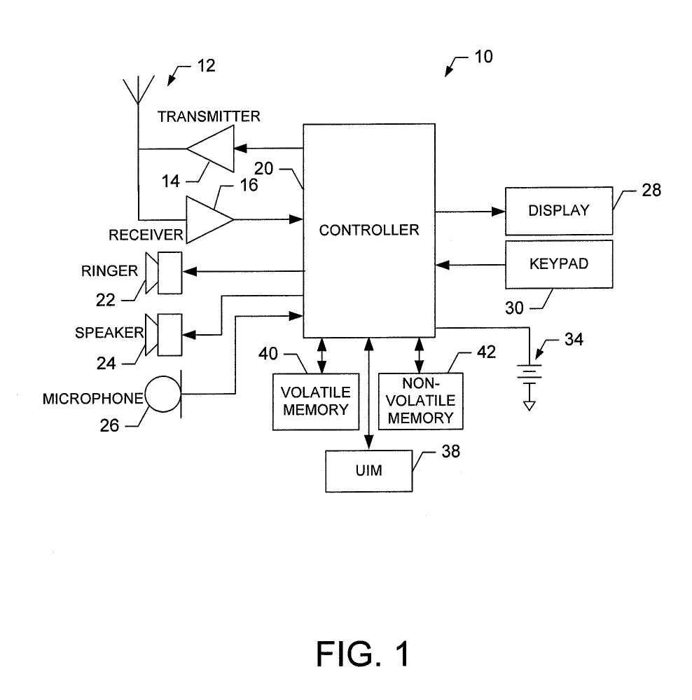

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

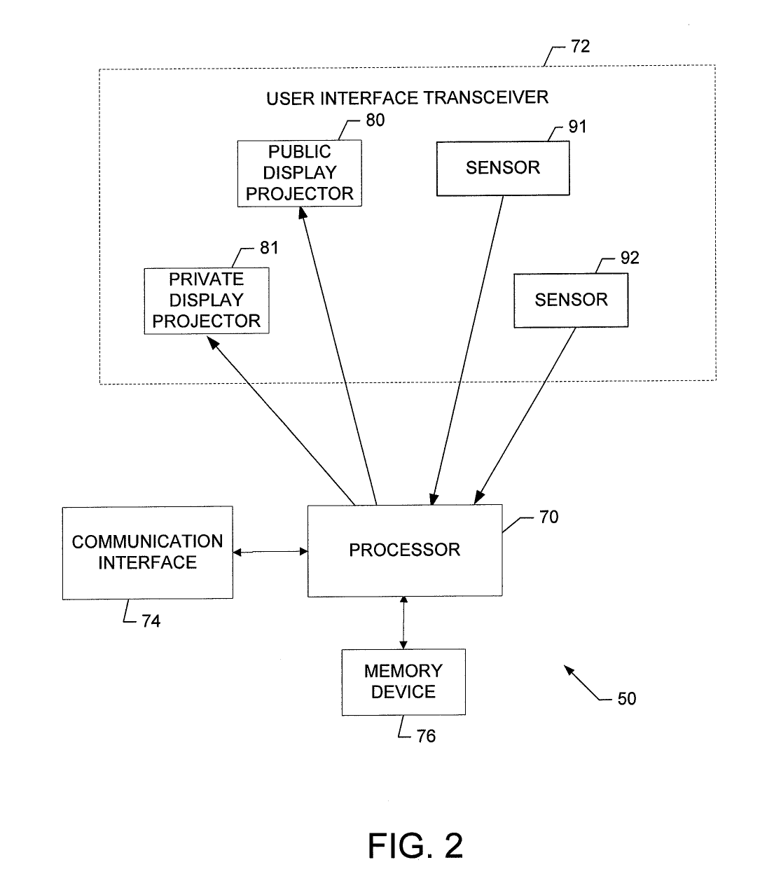

The mobile terminal 10 may include an antenna 12 (or multiple antennas) in operable communication with a transmitter 14 and a receiver 16. The mobile terminal 10 may further include an apparatus, such as a controller 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, in which certain elements of an apparatus 50 for providing a collaborative public display region for distributive management of content are depicted. The apparatus 50 of FIG. 2 may be employed, for example, in conjunction with the mobile terminal 10 of FIG. 1. However, it should be noted that the apparatus 50 of FIG. 2 may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for providing a collaborative public display region for distributive management of content, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for providing a collaborative public display region for distributive management of content may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. In exemplary embodiments described below, one or more display regions may be projected on a surface external to the apparatus 50, such as on a wall, a table, or some other surface, and input from the user may be received via interaction with the projected display region(s). For example, as described in greater detail below, the apparatus 50 may be configured to provide for the projection of 2 display regions—a collaborative public display region and a designated private display region. As such, the user interface transceiver 72 may include, for example, a public display projector 80 configured to generate the projection of the collaborative public display region and a private display projector 81 configured to generate the projection of the designated private display region on the surface.

The projectors 80, 81 may project the display regions in several different ways. For example, the projectors 80, 81 may use a masked LED (light emitting diode) to accomplish projection by overlaying an LED with a simple masking structure (e.g., fixed or seven segment) so that the light projected by the LED beyond the mask is projected. Alternatively, the projectors 80, 81 may be configured to generate the image through laser drawing. Furthermore, in some cases, the projectors 80, 81 may each comprise a conventional small color projector.

The user interface transceiver 72 may also include one or more sensors 91, 92 configured to detect the user's interaction with the display region(s), as described further below. Alternatively or additionally, the processor 70 may comprise user interface circuitry configured to control at least some functions of one or more elements of the display regions, such as, for example, the projectors 80, 81, a speaker, a ringer, a microphone, and/or the like. The processor 70 and/or user interface circuitry comprising the processor 70 may be configured to control one or more functions of one or more elements of the display regions through computer program instructions (e.g., software and/or firmware) stored on a memory accessible to the processor 70 (e.g., memory device 76, and/or the like).

Thus, in an example embodiment, the apparatus 50 may be configured to project a display region that simulates, for example, a computer desktop environment or other user interface on a surface external to the apparatus via the projector 80 and/or the sensor(s) 91, 92. The processor 70 may be in communication with the sensors 91, 92, for example, to receive indications of user inputs associated with the projected display region (i.e., the projected user interface) and to modify a response to such indications based on corresponding user actions that may be inferred or otherwise determined responsive to the indications, such as to provide for the transfer of data based on the input received, as described below.

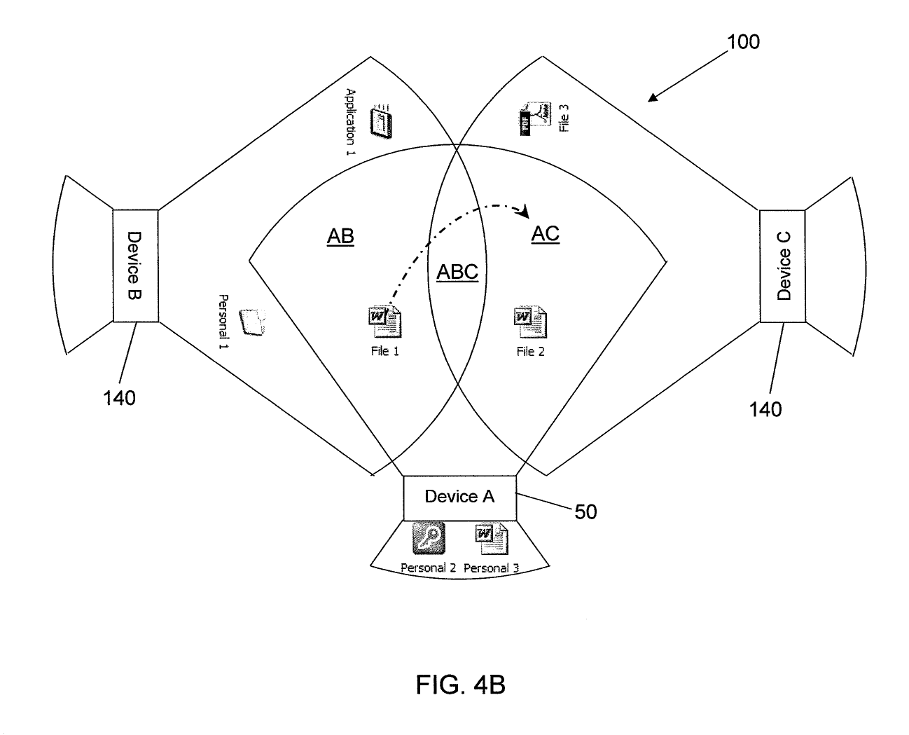

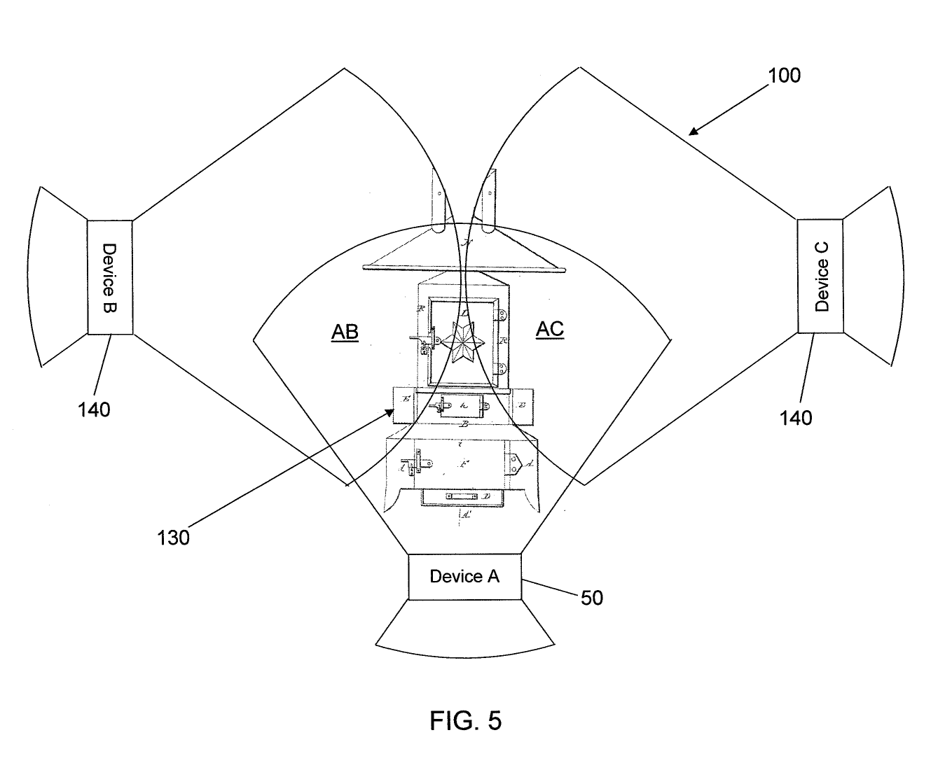

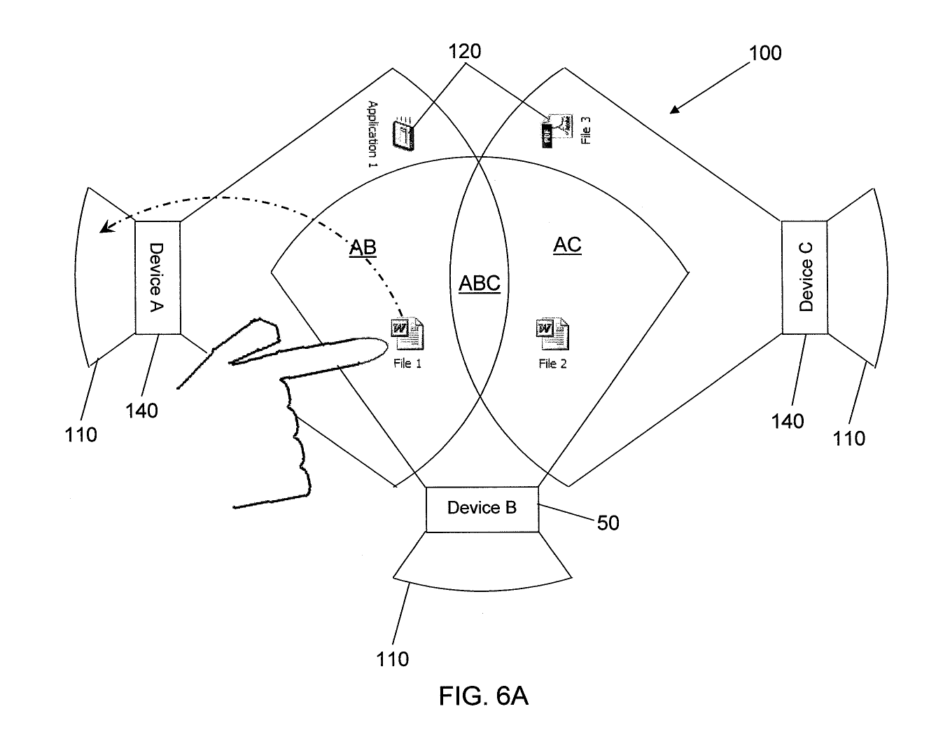

The projectors 80, 81 may, in some instances, be a portion of the user interface transceiver 72. However, in some alternative embodiments, the projectors 80, 81 may be embodied as the processor 70 or may be a separate entity controlled by the processor 70. The processor 70 may be co-located or integrally formed with one or both projectors 80, 81. For example, the mobile terminal 10 (FIG. 1) may be embodied in a cellular telephone, PDA, or other device and may include both the processor 70 and one or both projectors 80, 81 in some cases. Alternatively, the processor may be embodied in a separate device in communication with the projector and the sensors 91, 92, such as when the projector 80 is a peripheral device to a mobile terminal 10 (FIG. 1). Likewise, and as described in greater detail below with reference to FIGS. 4 and 5, one or more sensors 91, 92 may be co-located with the projector(s) 80, 81 and/or the processor 70, and/or embodied in one or more separate devices. As such, in some embodiments, the processor 70 may be said to cause, direct, or control the execution or occurrence of the various functions attributed to the user interface transceiver 72 (and any components of the user interface transceiver 72) as described herein.

The user interface transceiver 72 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the user interface transceiver 72 as described herein. Thus, in examples in which software is employed, a device or circuitry (e.g., the processor 70 in one example) executing the software forms the structure associated with such means.

The user interface transceiver 72 may be configured to receive an indication of an input in the form of a touch event at the projected display region(s). Thus, in some cases, the one or more sensors 91, 92 may be cameras that are arranged and configured to recognize a user's hand, a stylus, or some other marker of an input device acting on the projection surface. The sensed position of the user's hand or other input device may in turn be processed, taking into account, for example, the position of the display region on the projected surface and the position of the content projected in the display region. In other cases, the sensors 91, 92 may comprise audio sensors that are configured to detect sound waves associated with the touch inputs, such as taps on the projection or display surface. In any case, the processor 70 may classify the touch events and translate them into useful indications of user input. The processor 70 may further modify a response to such indications based on corresponding user actions that may be inferred or otherwise determined responsive to the indications. Following recognition of a touch event, the user interface transceiver 72 may be configured provide a corresponding function based on the touch event in some situations, as described below.

In this regard, a touch may be defined as a touch event that impacts a single area (without or with minimal movement on the surface upon which the display region is projected) and then is removed. A multi-touch may be defined as multiple touch events sensed at the same time (or nearly the same time). A stroke event may be defined as a touch event followed immediately by motion of the object initiating the touch event (e.g., the user's finger) while the object remains in contact with the projected display region. In other words, the stroke event may be defined by motion following a touch event, thereby forming a continuous, moving touch event defining a moving series of instantaneous touch positions (e.g., as a drag operation or as a flick operation). Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart. After initial occurrence of the multi-touch event involving at least two objects, one or more of the objects may move substantially toward each other to simulate a pinch. Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other.

In some embodiments, the projected display region may also be configured to enable the detection of a hovering gesture input. A hovering gesture input may comprise a gesture input to the display region without making physical contact with a surface upon which the display region is projected, such as a gesture made in a space some distance above/in front of the surface upon which the touch display is projected. As an example, the projected display region may comprise a projected capacitive touch display, which may be configured to enable detection of capacitance of a finger or other input object by which a gesture may be made without physically contacting the display surface. As another example, the display region may be configured to enable detection of a hovering gesture input through use of acoustic wave touch sensor technology, electromagnetic touch sensing technology, near field imaging technology, optical sensing technology, infrared proximity sensing technology, some combination thereof, or the like.

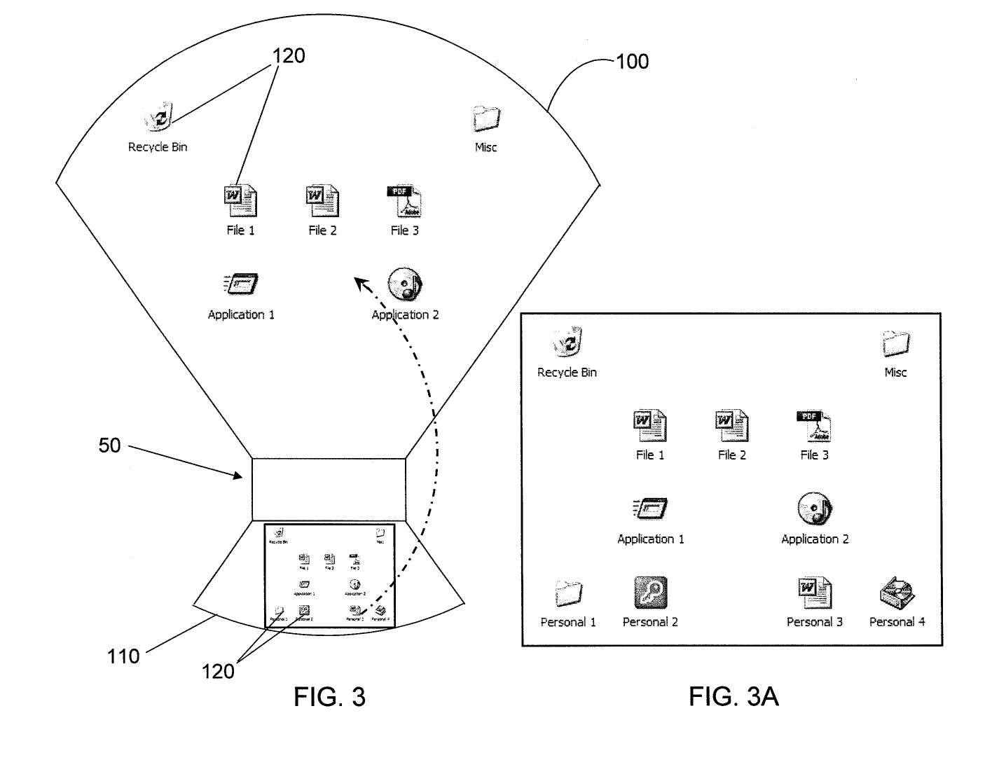

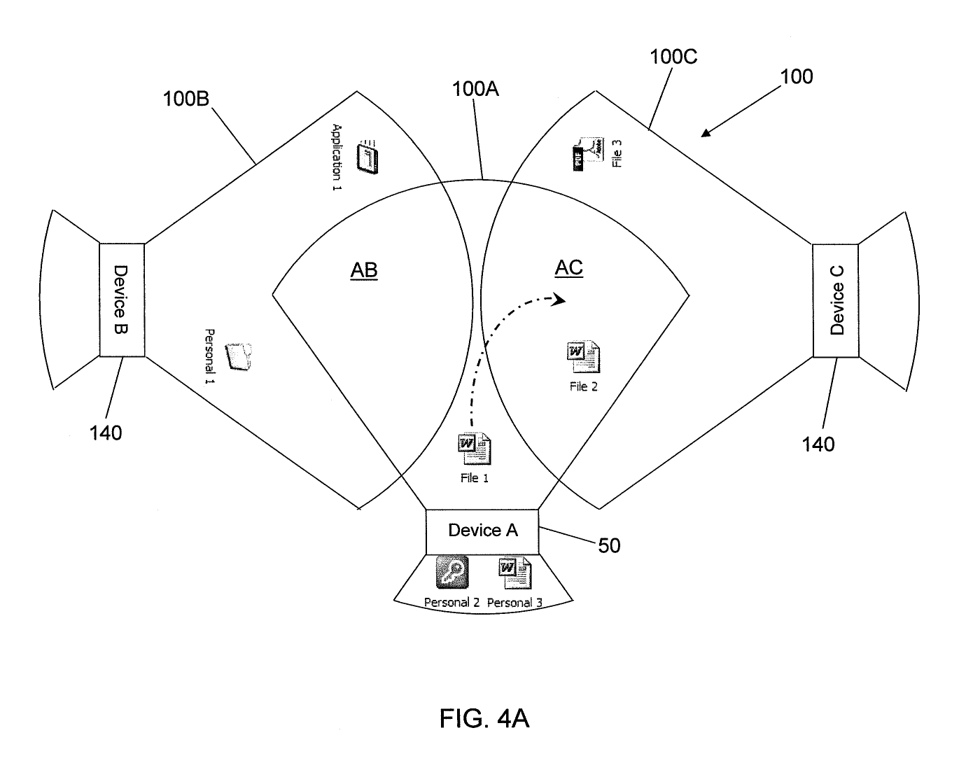

Turning now to FIG. 3, an apparatus 50 is provided that is configured to project one or more display regions 100, 110 onto a surface, such as a table or the floor. In the depicted embodiment, for example, the apparatus 50 is projecting two display regions—a collaborative public display region 100 and a designated private display region 110. The collaborative public display region 100 may be a shared zone, where the elements displayed may be viewable by user of the apparatus 50 and others in the vicinity. In addition, elements in the collaborative public display region 100 may be capable of manipulation by the user and others.

In contrast, elements projected in the designated private display region 110 may be private in the sense that they may be intended for viewing and manipulation by the user of the apparatus 50 only, and not others in the vicinity. In this regard, the elements displayed in the designated private display region 110 may have certain properties that prevent the elements from being shared with other users. For example, only the user of the apparatus 50 may have authorization to perform certain functions (e.g., open, copy, modify, transfer, etc.) on the elements displayed in the designated private display region 110, as described in greater detail below. Accordingly, in some embodiments, as illustrated, the designated private display region 110 may be a smaller projected area than the collaborative public display region 100. In other words, the apparatus 50 or the device in which the apparatus is embodied (such as the mobile terminal 10) may be thought of as a physical object that affords segmentation regions to a horizontal interactive workspace, identifying in the example described above a collaborative public display region for use by multiple users and a designated private display region for use by the user of the apparatus, only.

Various elements may be projected in the collaborative public display region 100 and/or the designated private display region 110. In FIGS. 3 and 3A, for example, the apparatus 50 is configured to project the image of a computer desktop with icons 120 representing different programs, files, applications, or other content that is accessible via the respective display region 100, 110. In other embodiments, however, the elements may include content such as a sketch or drawing 130 or portions of a sketch or drawing (shown in FIG. 5), text or portions of text, or other content that can be viewed, arranged, accessed and/or manipulated by one or more users.

In the depicted embodiment of FIGS. 3 and 3A, the collaborative public display region includes a Recycle Bin, two text documents (File 1 and File 2), a pdf document (File 3), a folder (Misc), and two applications (Application 1 and Application 2). Because these icons 120 are in the collaborative public display region 100, anyone in the vicinity, including users of other devices, may be able to interact with and/or view the content. For example, anyone may be able to “double-click” on Application 1 (e.g., by tapping on the projected surface where Application 1 is projected with a finger or a stylus twice in rapid succession) to run the application. Similarly, anyone may be able to transfer the content associated with the displayed icons 120 to another device (e.g., copy or move the content), as described in greater detail below.

Referring to FIG. 3A, which provides a close-up view of the computer desktop projected in the designated private display region 110 of FIG. 3, the icons 120 appearing in the collaborative public display region 100, as well as additional icons that are only available on the designated private display region may be displayed in the designated private display region. Thus, for example, content associated with Personal 1, Personal 2, Personal 3, and Personal 4 is only available for viewing and/or access via the designated private display region 110. As described in greater detail below, the user of the apparatus 50 may decide to share or provide other users with access to certain content that is only displayed in the designated private display region 110. In this case, for the scenario depicted in FIGS. 3 and 3A, the user may drag an icon 120 corresponding to private (e.g., unshared) content that is only displayed in the designated private display region 110 from the designated private display region to the collaborative public display region 100 (indicated by the dashed-line arrow). As a result, the dragged icon 120 may be displayed in the collaborative public display region 100, and the properties of the associated content may be changed to allow viewing and/or access by other users in addition to the user of the apparatus 50.

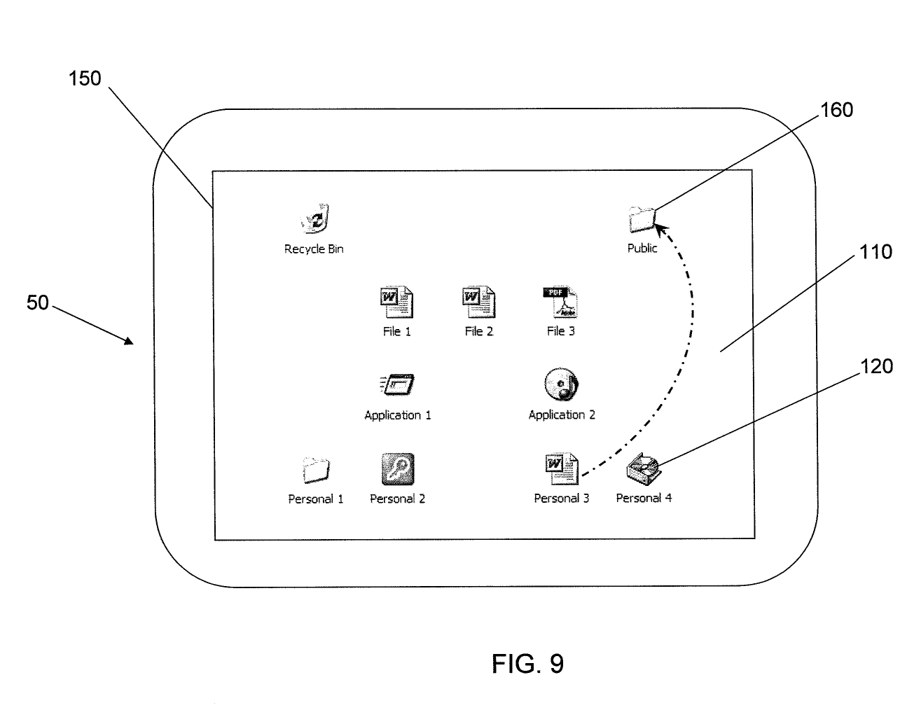

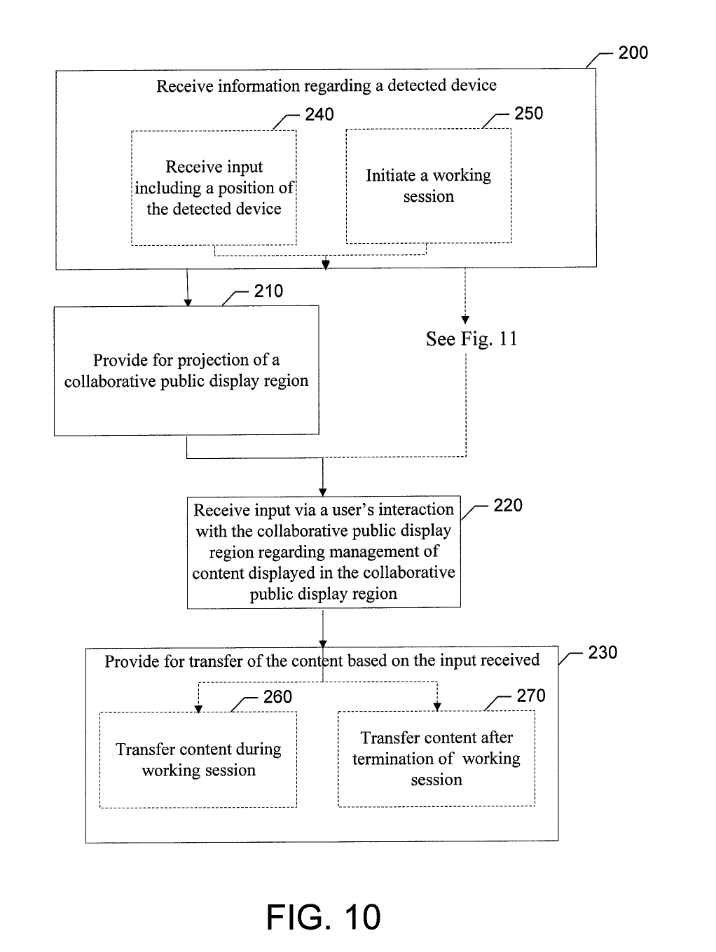

Although FIG. 3 depicts the designated private display region 110 as a projected space on one side of the apparatus 50 or the device in which the apparatus is embodied (such as the mobile terminal 10), for example, opposite the space where the collaborative public display region 100 is projected, the designated private display region may in some cases be provided on a display surface 160 of the apparatus 50, the mobile terminal 10, or a peripheral device, as shown in FIGS. 8 and 9, rather than projected onto an external surface. For example, in cases where the apparatus 50 is embodied on a cellular telephone, the designated private display region 110 may be displayed on a display screen of the cellular telephone, whereas the collaborative public display region 100 may be projected on a surface in the vicinity of the cellular telephone, such as a table top upon which the cellular telephone is placed.

Turning now to FIGS. 4A-7, embodiments of the apparatus 50 may be configured to provide for recognition of other devices in the vicinity of the apparatus 50 or the device in which the apparatus is embodied and may be configured to provide a collaborative public display region that is shared by recognized devices and allows for shared content to be transferred between recognized devices. In FIGS. 4A-6B, the apparatus 50 is or is embodied in Device A, and Devices B and C are other devices that may be detected by the apparatus and may initiate a working session with Device A, as described below.

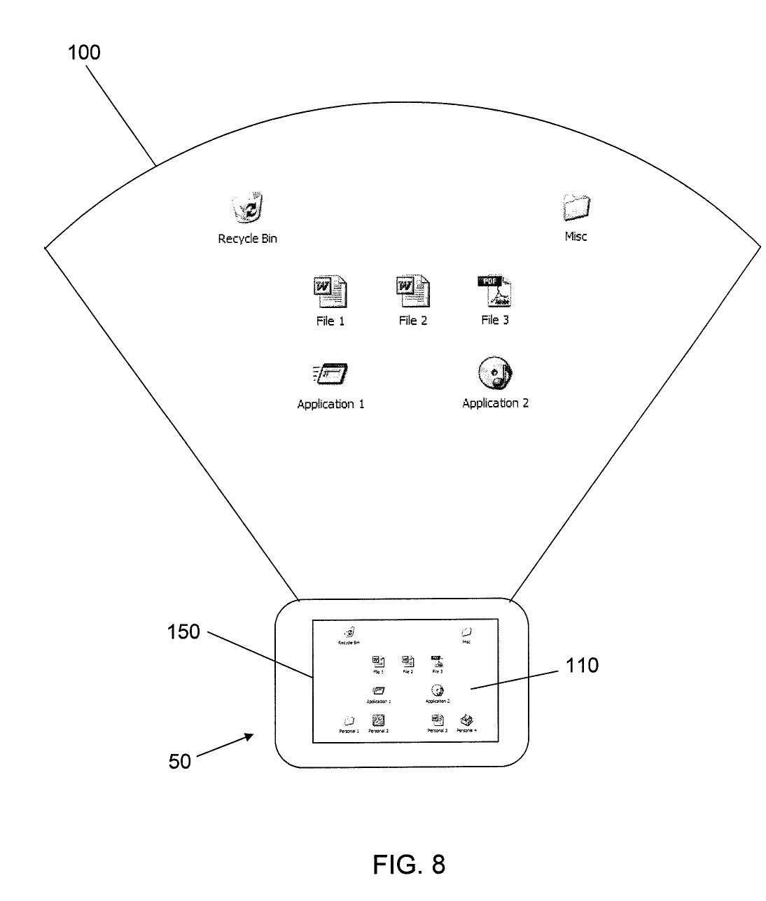

In particular, at least one memory of the apparatus 50 (e.g., the memory device 76 of FIG. 2) including computer program code may be configured to, with the processor 70, cause the apparatus to receive information regarding a detected device 140. For example, the apparatus 50 may use Bluetooth or other near field communication protocols to determine whether another device 140 is in its vicinity, such as by periodically transmitting signals inquiring whether another device is present in the field of transmission and, if such a device is present, requesting a response signal, as illustrated in FIG. 7. Thus, in some cases, the information regarding the detected device 140 is received based on a proximity of the detected device to the apparatus 50.

In some embodiments, the information regarding the detected device may include other data, in addition to an indication of proximity. For example, the response signal may include a configuration of the detected device 140, which may include information regarding a communications protocol that should be used by the apparatus 50 to communicate with the detected device, e.g., to facilitate the transfer of content. As another example, the response signal may include a position of the detected device, such as Global Positioning System (GPS) coordinates identifying the location of the device. In this way, the apparatus 50 may be able to determine the relative position of one or more detected devices 140 and the position of their respective projected collaborative public display regions with respect to the collaborative public display region projected by the apparatus 50 itself, as discussed below.

As noted above, the at least one memory including computer program code may be configured to, with the processor 70, cause the apparatus 50 to provide for projection of a collaborative public display region 100A. The collaborative public display region 100A may be shared with the detected device(s) 140, such that the users of the detected devices 140 may be authorized and/or have the ability to view the elements projected on the collaborative public display region 100A and may have access to and be able to manipulate those elements.

In some cases, each detected device 140 may also be configured to provide for projection of a collaborative public display region. For example, Device B may provide for projection of a collaborative public display region 100B, and Device C may provide for projection of a collaborative public display region 100C. Depending on the relative positions of Devices A, B, and C, the collaborative public display regions 100A, 100B, 100C may in some cases at least partially overlap with each other (shown in FIGS. 4A-6B). The projected areas of overlapping display regions may in some cases indicate shared ownership or control of the content projected in those areas.

In this regard, for example, Devices A, B, and C may be positioned relative to each other to create 3 areas of overlap, as shown in FIG. 4B. Area AB may be the area where the collaborative public display region 100A of Device A may overlap with the collaborative public display region 100B of Device B; area AC may be the area where the collaborative public display region 100A of Device A may overlap with the collaborative public display region 100C of Device C; and area ABC may be the area where the collaborative public display region 100A of Device A, the collaborative public display region 100B of Device B, and the collaborative public display region 100C of Device C may all overlap. In FIG. 4A, as another example, Devices B and C are positioned farther apart from each other. Thus, only 2 areas of overlap are formed at area AB and at area AC.

The at least one memory including computer program code may be configured to, with the processor 70, cause the apparatus 50 to receive input via a user's interaction with the collaborative public display region 100 regarding management of content displayed in the collaborative public display region. As shown in FIG. 4B, for example, the input may comprise a touch input dragging the content (which in some cases may be a representation of the content, such as an icon 120, as depicted) from a first area of the collaborative public display region 100A (e.g., area AB) to a second area of the collaborative public display region 100A (e.g., area AC). In embodiments where the apparatus 50 and the detected devices 140 are arranged as shown in FIG. 4A, the input may comprise a touch input dragging the content from the collaborative public display region 100A of the apparatus to a collaborative public display region of one of the detected devices 140 (e.g., area AC). Although the example mentioned above describe dragging of the icon 120, other types of user input may be recognized, depending on the configuration of the apparatus 50, such as tapping on the icon in its original position and then tapping on the display surface in the area of the collaborative public display regions 100A, 100B, 100C to indicate the desired destination of the content.

In some cases, the ownership properties of the content may be changed as a result of the touch input moving the location of the display of the content. For example, dragging the content from a first area of the collaborative public display region 100A (e.g., area AB) to a second area of the collaborative public display region (e.g., area AC) may effect the transmission of instructions to the respective detected device (e.g., Device C) regarding the projection of the content, only. In this way, multiple collaborative public display regions corresponding to multiple devices can provide the users with a cohesive display of the content (e.g., with the content displayed in the proper orientation regardless of the particular orientation of the different devices). Thus, in the example of FIG. 5, sharing the content (in this case, a sketch 130) initially residing on Device A with Devices B and C may transmit instructions to Devices B and C regarding how to collaboratively project the sketch, as shown. For example, Device B may receive instructions regarding how to project the relevant portion of the sketch in area AB, and Device C may receive instructions regarding how to project the relevant portion of the sketch in area AC to provide a cohesive view of the sketch 130 over the collaborative public display area 100.

In other cases, the at least one memory including computer program code may be configured to, with the processor 70, cause the apparatus 50 to provide for transfer of the content based on the input received. In other words, the dragging of an icon 120 described above with respect to FIGS. 4A and 4B may not only serve to move the position of the icon from its original location to, or provide for the display of content on, the collaborative public display region 100 of multiple devices, but may also be recognized as an instruction to transfer the content from the apparatus 50 (e.g., the memory device 76 of FIG. 2) to a corresponding memory of the destination device. In some cases, the entire content itself may be transferred in response to the input received (e.g., a copy of the content may be provided to the detected device 140 that is indicated as the destination). In other cases, however, only a portion of the content (such as a header) or instructions regarding the transfer of the content may be transmitted to the destination device 140 in response to the input received. Such instructions may include, for example, information identifying the source of the content, the size of the content, and/or any authorizations required to access the content.

For example, in some embodiments, when the apparatus 50 receives information regarding the detected device 140 (e.g., a response signal indicating that the detected device 140 is in the vicinity of the apparatus 50), a working session between the apparatus and the detected device 140 may be initiated. The working session may, for example, be initiated via the establishment of a communications link between the apparatus 50 and the detected device 140. Thus, in some cases, the transfer of content may occur during the working session. In other cases, however, such as when only a portion of the content or instructions regarding the transfer is transmitted during the working session, the transfer of the content may occur after the working session has been terminated. For example, once the detected device 140 uncouples from its connection with the apparatus 50 (e.g., terminates the communications link), the detected device may be able to use the information provided during the working session to gain access to the content, either from the apparatus or from another source of content (e.g., the Internet or an external server on which the content is stored).

In some embodiments, as noted above, the at least one memory including computer program code may be configured to, with the processor 70, cause the apparatus 50 to also provide for display of a designated private display region, in addition to the collaborative public display region. The designated private display region 110 may be projected on a surface, as illustrated in FIG. 3, for example. In other cases, the designated private display region 110 may be generated on a screen 150 of the apparatus 50, as shown in FIG. 8. The content displayed in the designated private display region 110 may be viewable and/or accessible only by the user of the apparatus 50, as described above. In addition, the content displayed in the designated private display region 110 may be associated with ownership and/or control protocols such that only the user of the apparatus 50 is authorized to transfer the “private” content to other devices or modify the content. For example, a user wishing to modify content displayed in the designated private display region 110 (e.g., to delete a portion of the content or add to the content) may be required to first provide a password or other information identifying the user as an authorized user. In some cases, the location of the designated private display region (e.g., in an area close to the particular user of the apparatus 50 or on the apparatus itself) may be such that it is assumed that only the authorized user of the apparatus would have access to view or change the content or transfer the content to other devices.

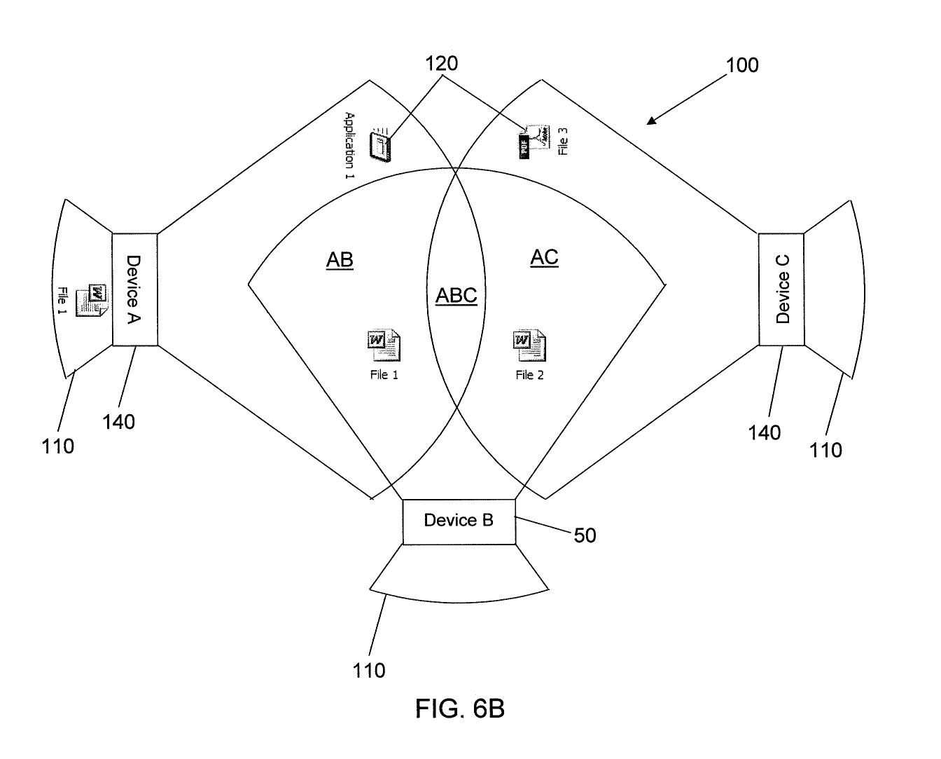

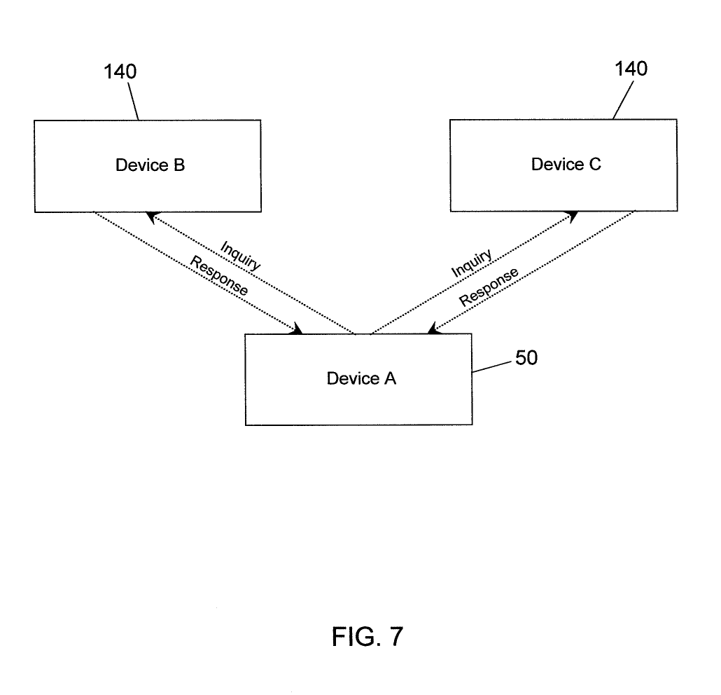

The at least one memory including computer program code may be configured to, with the processor 70, cause the apparatus 50 to receive input via a user's interaction with the designated private display region 110 regarding management of the content displayed in the designated private display region and to provide for the display of the content in the collaborative public display region 100 based on the input received via the designated private display region. For example, in embodiments such as that depicted in FIGS. 6A and 6B, content may be moved from the designated private display region 110 to the collaborative public display region 100 via the dragging of a icon 120 associated with the document to be shared from one display region to the other, as indicated by the arrow in FIG. 6A. Thus, in this example, the input may comprise the user's touch input on the projection surface of the designated private display region 110 and/or the collaborative public display region 100. As a result of the touch input, the selected file (e.g., File 1 in FIGS. 6A and 6B) may be copied to the destination location (Device A in FIG. 6B) for viewing and/or manipulation.

In other embodiments in which the designated private display region 110 is displayed on a screen 150 of the apparatus 50, rather than projected, as shown in FIGS. 8 and 9, the content (e.g., an icon 120 representing the content) may be dragged and dropped via the user's touch input into a “Public” folder 160 or other representation of the collaborative public display region 100 displayed in the designated private display region, as depicted. In some cases, embodiments in which the designated private display region 110 is projected (such as in FIG. 3) may also include a “Public” folder 160 (shown in FIG. 9) or other representation of the collaborative public display region 100 in designated private display region and/or may include a “Private” folder (not shown) or other representation of the designated private display region in the collaborative public display region 100 to allow content to be moved between display regions and to change the properties of the moved content, respectively.

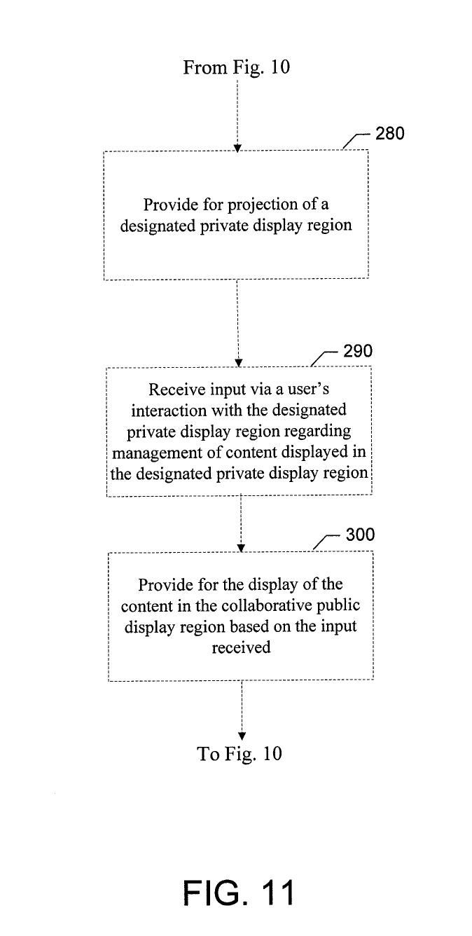

FIGS. 10 and 11 illustrate a flowchart of a system, method, and computer program product according to example embodiments of the invention. It will be understood that each block of the flowchart, and combinations of blocks in the flowchart, may be implemented by various means, such as hardware, firmware, processor, circuitry, and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method for distributively managing content among multiple user devices, as shown in FIGS. 10 and 11, includes receiving information regarding a detected device at operation 200. A projection of a collaborative public display region may be provided at operation 210, as described above, wherein the collaborative public display region is shared with the detected device. For example, a sketch or figure (as shown in FIG. 5) meeting notes, brainstorming ideas, or other content may be displayed in the collaborative public display region. Similarly, representations of content, such as icons, as shown in FIGS. 4A and 4B, may be displayed in the collaborative public display region. Input may be received via a user's interaction with the collaborative public display region regarding management of content displayed in the collaborative public display region at operation 220, and transfer of the content may be provided for based on the input received at operation 230. In other words, multiple users may be able to interact with the content displayed in the collaborative public display region to view and/or modify the content and to transfer the content to their own devices, as described above in connection with FIGS. 3-10.

In some cases, the information regarding the detected device may include the position of the detected device. Operation 240. In addition to determining whether a device is in proximity to the apparatus, for example, to facilitate the establishment of a communications link with the detected device, such information may allow the apparatus to determine areas of joint ownership and/or control of content based on the areas of overlapping display regions, as described above. The receipt of information regarding the detected device may initiate a working session at operation 250, and content may be transferred during the working session (at operation 260) or after termination of the working session (at operation 270), as described above.

As noted above, the input regarding management of the content may include a touch input dragging the content from the collaborative public display region of the apparatus to a collaborative public display region of one of the detected devices. Alternatively or additionally, the input regarding management of the content may include a touch input dragging the content from a first area of the collaborative public display region to a second area of the collaborative public display region.

In some embodiments, a projection of a designated private display region may be provided at operation 280. Furthermore, input may be received at operation 290 via a user's interaction with the designated private display region regarding management of the content displayed in the designated private display region, and the display of the content in the collaborative public display region may be provided for based on the input received via the designated private display region at operation 300.

In some embodiments, certain ones of the operations above may be modified or further amplified as described below. Furthermore, in some embodiments, additional optional operations may be included, some examples of which are shown in dashed lines in FIGS. 10 and 11. Modifications, additions, or amplifications to the operations above may be performed in any order and in any combination.

In an example embodiment, an apparatus for performing the method of FIGS. 10 and 11 above may comprise a processor (e.g., the processor 70 of FIG. 2) configured to perform some or each of the operations (200-300) described above. The processor may, for example, be configured to perform the operations (200-300) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200 and 230-270 may comprise, for example, the processor 70 and/or a device or circuit for executing instructions or executing an algorithm for processing information as described above. Examples of means for performing operations 210-220 and 280-300 may comprise, for example, the processor 70, the user interface transceiver 72, and/or a device or circuit for executing instructions or executing an algorithm for processing information as described above.

Although the description and associated figures provide examples of content comprising a sketch and icons representing content, numerous other types of content, including text and images, may be projected. For example, the content may comprise a streaming video, such as a movie, a game, a list of contacts, an internet website, or numerous other types of data and applications. In addition, the content may be stored on the apparatus 50 or the device 140 (e.g., in a memory 76 of the apparatus), or in a memory located apart from the apparatus or device that is accessible via the apparatus or device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
receive information regarding a detected device;
provide for projection of a collaborative public display region, wherein the collaborative public display region is shared with the detected device;
receive input via a user's interaction with the collaborative public display region regarding management of content displayed in the collaborative public display region; and
provide for transfer of the content based on the input received.

2. The apparatus of claim 1, wherein the information regarding the detected device is received based on a proximity of the detected device to the apparatus.

3. The apparatus of claim 1, wherein the information regarding the detected device includes a position of the detected device.

4. The apparatus of claim 1, wherein receiving information regarding the detected device initiates a working session, and wherein the content is transferred during the working session.

5. The apparatus of claim 1, wherein receiving information regarding the detected device initiates a working session, and wherein the content is transferred after termination of the working session.

6. The apparatus of claim 1, wherein the input regarding management of the content comprises a touch input dragging of the content from the collaborative public display region of the apparatus to a collaborative public display region of one of the detected devices.

7. The apparatus of claim 1, wherein the input regarding management of the content comprises a touch input dragging of the content from a first area of the collaborative public display region to a second area of the collaborative public display region.

8. The apparatus of claim 1, wherein providing for the transfer of the content comprises providing a copy of the content to the detected device based on the input received.

9. The apparatus of claim 1, wherein the memory and computer program code are further configured to, with the processor, cause the apparatus to provide for display of a designated private display region.

10. The apparatus of claim 9, wherein the memory and computer program code are further configured to, with the processor, cause the apparatus to:
receive input via a user's interaction with the designated private display region regarding management of content displayed in the designated private display region; and
provide for the display of the content in the collaborative public display region based on the input received via the designated private display region.

11. A method comprising:
receiving information regarding a detected device;
providing for projection of a collaborative public display region, wherein the collaborative public display region is shared with the detected device;
receiving input via a user's interaction with the collaborative public display region regarding management of content displayed in the collaborative public display region; and
providing for transfer of the content based on the input received.

12. The method of claim 11, wherein the information regarding the detected device includes a position of the detected device.

13. The method of claim 11, wherein receiving information regarding the detected device initiates a working session, and wherein the content is transferred during the working session.

14. The method of claim 11, wherein receiving information regarding the detected device initiates a working session, and wherein the content is transferred after termination of the working session.

15. The method of claim 11, wherein the input regarding management of the content comprises a touch input dragging of the content from the collaborative public display region of the apparatus to a collaborative public display region of one of the detected devices.

16. The method of claim 11, wherein the input regarding management of the content comprises a touch input dragging of the content from a first area of the collaborative public display region to a second area of the collaborative public display region.

17. The method of claim 11 further comprising providing for projection of a designated private display region.

18. The method of claim 11 further comprising:
receiving input via a user's interaction with the designated private display region regarding management of content displayed in the designated private display region; and
providing for the display of the content in the collaborative public display region based on the input received via the designated private display region.

19. A computer program product comprising at least one computer-readable storage medium having computer-executable program code portions stored therein, the computer-executable program code portions comprising program code instructions for:
receiving information regarding a detected device;
providing for projection of a collaborative public display region, wherein the collaborative public display region is shared with the detected device;
receiving input via a user's interaction with the collaborative public display region regarding management of content displayed in the collaborative public display region; and
providing for transfer of the content based on the input received.

20. The computer program product of claim 19 further comprising program code instructions for wherein the program code instructions for providing for the transfer of the content include instructions for providing for projection of a designated private display region, receiving input via a user's interaction with the designated private display region regarding management of content displayed in the designated private display region, and providing for the display of the content in the collaborative public display region based on the input received via the designated private display region.
